(19) United States
(12) Patent Application Publication
(10) Pub. No.: US 2025/0036799 A1
(43) Pub. Date: Jan. 30, 2025

(54) OBSCURING PERSONAL INFORMATION IN VIDEOS

(71) Applicant: International Business Machines Corporation, Armonk, NY (US)

(72) Inventors: Joseph Lam, Markham (CA); Diane Chalmers, Rochester, MN (US); Mikael Hillborg, Umeå (SE); Mohini Setia, Gurgaon (IN); Adinarayana Haridas, Hyderabad (IN)

(21) Appl. No.: 18/361,026

(22) Filed: Jul. 28, 2023

(51) Int. Cl. G06F 21/62; G11B 27/031

(52) U.S. Cl. CPC G06F 21/6245; G11B 27/031; G06V 20/46; G06V 30/30

(57) ABSTRACT

In an approach to obscuring personal information in videos, one or more computer processors receive a video. One or more computer processors extract text from a first frame of the video. One or more computer processors determine a personal information object is detected in the extracted text. One or more computer processors obscure the personal information object in the first frame. One or more computer processors perform the previous steps on each frame in the video.

### BACKGROUND OF THE INVENTION

The present invention relates generally to the field of managing sensitive data, and more particularly to obscuring personal information in videos.

Data sanitization, data obfuscation, and/or data obscuring techniques refer to techniques that remove or replace the sensitive text or information in documents, in a manner that does not expose identifiable information or confidential information. When these desensitized or obscured documents are shared, the end users are then not able to gather any personal information related to individual data entities.

Enterprises attempt to strike a balance between protecting their sensitive, or personal, data while allowing their personnel to utilize that sensitive data when needed in the operations of the enterprise, both internally and externally. Sensitive data often consists of employee, customer, partner, and vendor records containing sensitive details, for example, names of individuals, addresses, telephone numbers, email addresses, social security numbers, credit card information, biometric data, health insurance details, health records, and financial records. Such sensitive information is often shared through a variety of applications, including mobile applications, which may be viewed internally and externally with proper authorization. Enterprises take steps to keep such sensitive data private both to protect their own interests and the interests of their clients, partners, and customers. Much of this data is required by law to be kept private. For example, the Payment Card Industry Data Security Standard (PCI DSS) act makes it mandatory for credit card payment processing companies to maintain data confidentiality while storing, processing, and exchanging credit card data. In another example, the General Data Protection Regulation (GDPR) is a regulation in European Union (EU) law on data protection and privacy in the EU and the European Economic Area (EEA). A further example is the California Consumer Protection Act (CCPA) which is targeted toward privacy of data of individuals.

### SUMMARY

Embodiments of the present invention disclose a computer-implemented method, a computer program product, and a system for obscuring personal information in videos. The computer-implemented method may include one or more computer processors receiving a video. One or more computer processors extract text from a first frame of the video. One or more computer processors determine a personal information object is detected in the extracted text. One or more computer processors obscure the personal information object in the first frame. One or more computer processors perform the previous steps on each frame in the video.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a video obscuring program, on a server computer within the distributed data processing environment of FIG. 1, for obscuring personal information in videos, in accordance with an embodiment of the present invention; and

FIG. 3 illustrates an exemplary computer environment in which aspects of one or more of the illustrative embodiments may be implemented, and at least some of the computer code involved in performing the inventive methods may be executed, in accordance with an embodiment of the present invention.

### DETAILED DESCRIPTION

Video editors can spend millions of hours each year to manually obscure personal information (PI) in videos using various techniques to mask, blur, and/or redact the PI from the videos. Technologies exist that automatically detect and blur faces in video segments with artificial intelligence (AI), but a technology does not currently exist that automatically obscures PI in a video. Embodiments of the present invention recognize that accidental sharing of personal information and/or data may be prevented by providing a system that automatically detects and obscures PI in videos by identifying and obscuring the PI in each video frame. Embodiments of the present invention recognize that efficiency may be gained by employing a system that automatically and systematically obscures personal information from a video frame with no manual effort required. Implementation of embodiments of the invention may take a variety of forms, and exemplary implementation details are discussed subsequently with reference to the Figures.

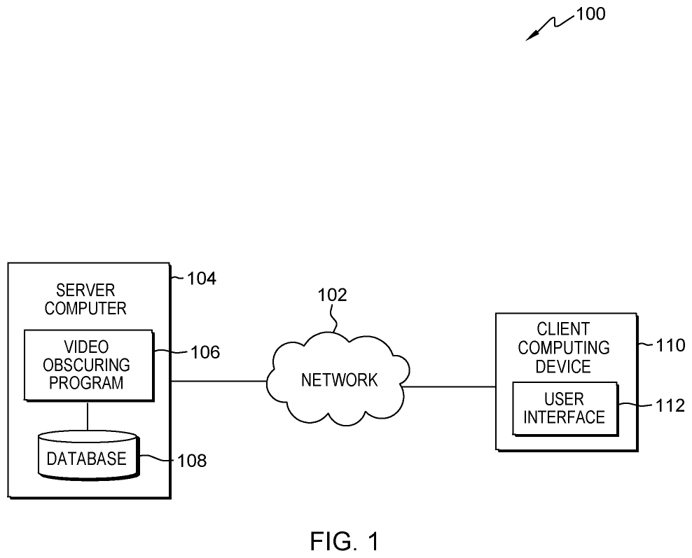

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

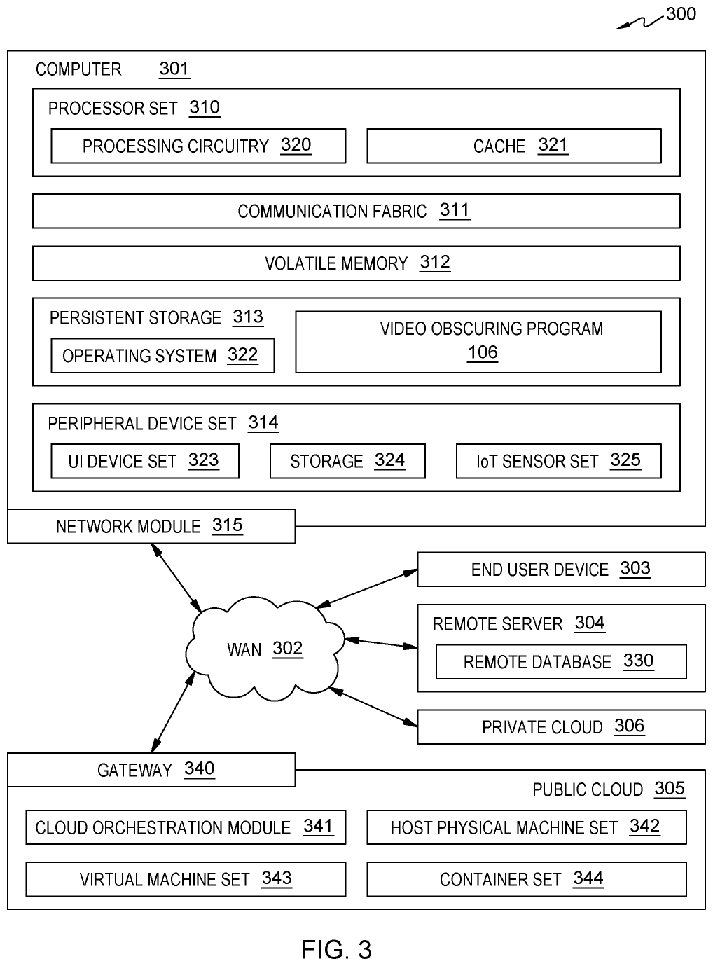

Distributed data processing environment 100 includes server computer 104 and client computing device 110, interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, client computing device 110, and other computing devices (not shown) within distributed data processing environment 100. Distributed data processing environment 100 may be implemented in computing environment 300 shown in FIG. 3.

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, an edge device, a containerized workload, or any programmable electronic device capable of communicating with client computing device 110 and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes video obscuring program 106 and database 108. Server computer 104 may include internal and external hardware components, as depicted and described in further detail with respect to computer 301 of FIG. 3.

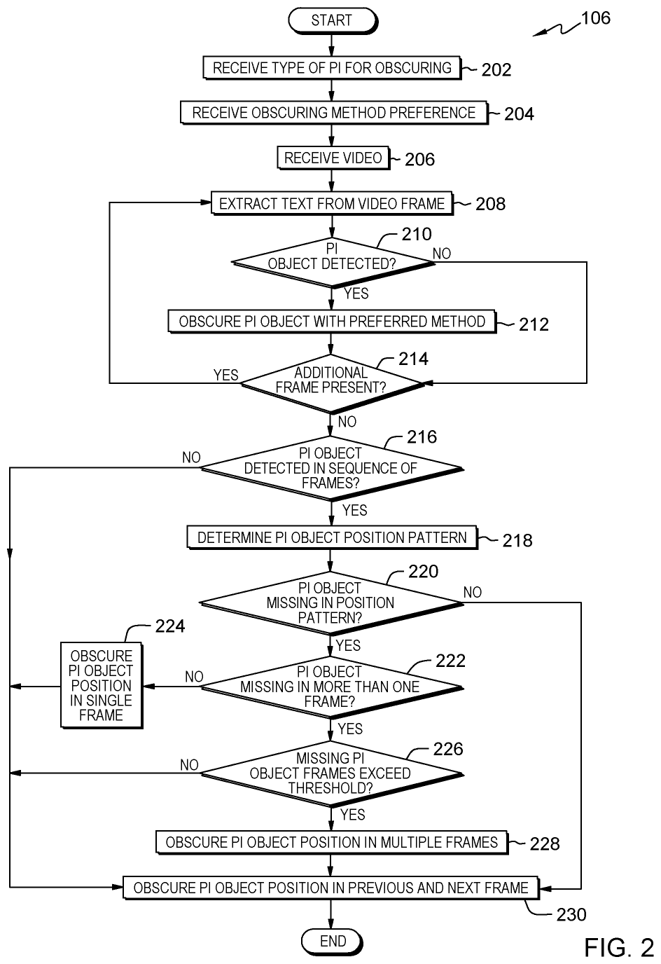

Video obscuring program 106 uses a combination of text recognition and PI detection techniques to find, identify, and locate PI in videos. Upon discovery of PI, video obscuring program 106 applies one or more of a plurality of obscuring techniques and/or methods to hide the PI in the video frame such that any viewer of the video cannot view the PI. Video obscuring program 106 receives a type of PI for obscuring. Video obscuring program 106 receives an obscuring method preference. Video obscuring program 106 receives a video. Video obscuring program 106 extracts text from a video frame. If video obscuring program 106 detects a PI object in the frame, then video obscuring program 106 obscures the PI with the preferred method. Subsequent to reviewing each frame in the video for PI, video obscuring program 106 determines if PI is present in a sequence of video frames, and, if so, then video obscuring program 106 determines a pattern of a position of the PI object. Video obscuring program 106 determines whether the PI object is missing in the pattern, and, if so, then video obscuring program 106 determines whether the PI object is missing in more than one frame. If video obscuring program 106 determines the PI object is not missing in more than one frame, then video obscuring program 106 obscures the PI object position in the single frame. If video obscuring program 106 determines the PI object is missing in more than one frame, then video obscuring program 106 determines whether the number of frames missing the PI object exceeds a pre-defined threshold. If video obscuring program 106 determines the number of frames missing the PI object exceeds a pre-defined threshold, then video obscuring program 106 obscures the PI object in multiple frames. Responsive to obscuring the PI in either a single frame or multiple frames, video obscuring program 106 obscures the position of the PI object in the previous frame and the next frame. Video obscuring program 106 is depicted and described in further detail with respect to FIG. 2.

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails and texts begin with a written notification that the user's information may be recorded or monitored and may be saved, for the purpose of obscuring personal information in videos. These embodiments may also include periodic reminders of such recording and monitoring throughout the course of any such use. Certain embodiments may also include regular (e.g., daily, weekly, monthly) reminders to the participating parties that they have consented to being recorded and monitored for obscuring personal information in videos and may provide the participating parties with the opportunity to opt-out of such recording and monitoring if desired. Furthermore, to the extent that any non-participating parties' actions are monitored (for example, when outside vehicles are viewed), such monitoring takes place for the limited purpose of providing navigation assistance to a participating party, with protections in place to prevent the unauthorized use or disclosure of any data for which an individual might have a certain expectation of privacy.

In the depicted embodiment, database 108 resides on server computer 104. In another embodiment, database 108 may reside elsewhere within distributed data processing environment 100, provided that video obscuring program 106 has access to database 108, via network 102. A database is an organized collection of data. Database 108 can be implemented with any type of storage device capable of storing data and configuration files that can be accessed and utilized by video obscuring program 106 such as a database server, a hard disk drive, or a flash memory. Database 108 stores information used by and generated by video obscuring program 106. For example, database 108 stores one or more videos from which video obscuring program 106 obscures PI and/or any text extracted from a video frame. Database 108 also stores metadata associated with each video frame on which video obscuring program 106 obscured PI. For example, the metadata may include coordinates that indicate the position within the frame where the PI was detected and obscured. Additionally, database 108 stores any detected patterns of PI positioning in video frames. Database 108 also stores user preferences for one or more methods of obscuring PI. Database 108 may also store a preferred and/or selected interpolation method. Further, database 108 stores user selections of one or more types of PI for obscuring, as well as a user selection of a number of frames to obscure previous to and following a video frame or a set of video frames with a detected PI object.

The present invention may contain various accessible data sources, such as database 108, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Video obscuring program 106 enables the authorized and secure processing of personal data. Video obscuring program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Video obscuring program 106 provides information regarding personal data and the nature (e.g., type, scope, purpose, duration, etc.) of the processing. Video obscuring program 106 provides the user with copies of stored personal data. Video obscuring program 106 allows the correction or completion of incorrect or incomplete personal data. Video obscuring program 106 allows the immediate deletion of personal data.

Client computing device 110 can be one or more of a laptop computer, a tablet computer, a smart phone, smart watch, a smart speaker, or any programmable electronic device capable of communicating with various components and devices within distributed data processing environment 100, via network 102. Client computing device 110 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch or a smart tattoo. In an embodiment, client computing device 110 may be integrated into a vehicle. For example, client computing device 110 may be a heads-up display in the windshield of the vehicle. In an embodiment where client computing device 110 is integrated into the vehicle, client computing device 110 includes a programmable, embedded Subscriber Identity Module (eSIM) card (not shown) that includes a unique identifier of the vehicle in addition to other vehicle information. In general, client computing device 110 represents one or more programmable electronic devices or combination of programmable electronic devices capable of executing machine readable program instructions and communicating with other computing devices (not shown) within distributed data processing environment 100 via a network, such as network 102. Client computing device 110 includes an instance of user interface 112.

User interface 112 provides an interface between video obscuring program 106 on server computer 104 and a user of client computing device 110. In one embodiment, user interface 112 is mobile application software. Mobile application software, or an “app,” is a computer program designed to run on smart phones, tablet computers and other mobile devices. In one embodiment, user interface 112 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In an embodiment, user interface 112 enables a user of client computing device 110 to input data to be used by video obscuring program 106, such as a type of PI to be obscured. In an embodiment, user interface 112 enables a user of client computing device 110 to input preferences for one or more methods of obscuring PI. In an embodiment, user interface 112 enables a user to submit a video for PI obscuring to video obscuring program 106. In an embodiment, user interface 112 enables a user to select a preferred interpolation method. In an embodiment, user interface 112 enables a user to select the number of frames to obscure previous to and following a video frame or a set of video frames with a detected PI object.

FIG. 2 is a flowchart depicting operational steps of video obscuring program 106, on server computer 104 within distributed data processing environment 100 of FIG. 1, for obscuring personal information in videos, in accordance with an embodiment of the present invention.

Video obscuring program 106 receives a type of PI for obscuring (step 202). In an embodiment, when a user of client computing device 110 transmits a type of PI for obscuring. via user interface 112, video obscuring program 106 receives the type of PI for obscuring. In an embodiment, video obscuring program 106 displays an interactive list of PI types in user interface 112, and video obscuring program 106 receives a selection of one or more types of PI from the list by the user. In an embodiment, when a user stores one or more types of PI to filter from a video in database 108, video obscuring program 106 retrieves the type of PI from database 108. For example, types of PI for obscuring may include, but are not limited to, names, contact information, such as addresses, email addresses, and phone numbers, social security numbers, driver's license numbers, passport numbers, credit card numbers, account numbers, license plate numbers, medical information, and any other data considered to be personal information. In another embodiment, the user may store additional types of information to be obscured that are not personal information. For example, the user may specify that company names are a type of data to be obscured.

Video obscuring program 106 receives an obscuring method preference (step 204). In an embodiment, when a user of client computing device 110 transmits an obscuring method preference, via user interface 112, video obscuring program 106 receives the obscuring method preference. In an embodiment, video obscuring program 106 displays an interactive list of an obscuring methods in user interface 112, and video obscuring program 106 receives a selection of one or more obscuring methods from the list by the user. In an embodiment, when a user stores one or more obscuring method preferences in database 108, video obscuring program 106 retrieves the obscuring method preferences from database 108. As referred to herein, obscuring methods include, but are not limited to, masking the PI, blurring the PI, and redacting the PI. For example, masking can include overlaying a label, a placeholder, or an opaque shape on the position of the PI in the video frame. In an embodiment, video obscuring program 106 includes placement of a border around the obscuring object to ensure that the obscuring includes coverage and selectivity of the PI object with a margin. In an embodiment, video obscuring program 106 adjusts a thickness of the border relative to the size of the PI object being obscured. In another example, blurring can include a degree of blur of the PI from minimum to maximum. In a further example, redacting can include replacing the PI in the video frame with an asterisk or other symbols.

Video obscuring program 106 receives a video (step 206). In an embodiment, when a user of client computing device 110 submits a video, via user interface 112, video obscuring program 106 receives the video. In an embodiment, video obscuring program 106 displays an interactive list of videos in user interface 112, and video obscuring program 106 receives a selection of one or more videos from the list by the user. In an embodiment, when a user stores one or more videos in database 108, video obscuring program 106 retrieves the video from database 108.

Video obscuring program 106 extracts text from a video frame (step 208). In an embodiment, video obscuring program 106 uses one or more text extraction techniques to extract text from the video frame. For example, video obscuring program 106 may use one or more optical character recognition (OCR) techniques, as would be recognized by a person of skill in the art, to extract text from a frame of the video.

Video obscuring program 106 determines whether a PI object is detected (decision block 210). In an embodiment, video obscuring program 106 analyzes the extracted text and identifies whether any PI object is detected in the video frame. For example, using OCR, video obscuring program 106 detects whether a name or social security number is visible in the frame.

If video obscuring program 106 detects a PI object in the frame (“yes” branch, decision block 210), then video obscuring program 106 obscures the PI with the preferred method (step 212). In an embodiment, if video obscuring program 106 identifies a PI object in the video frame, then video obscuring program 106 obscures the PI object using the preferred obscuring method determined in step 204. For example, if video obscuring program 106 detects a phone number in the video frame, and the user's preferred obscuring method is masking, then video obscuring program 106 overlays a black rectangle over the phone number in the video frame. In an embodiment, video obscuring program 106 stores the PI object with metadata that describes the video frame in which the PI object is detected and the position in the video frame where the PI object occurred in database 108. In the embodiment, a user can then search this information in database 108 for occurrences of PI objects.

Responsive to obscuring the PI with the preferred method, or if video obscuring program 106 does not detect a PI object in the frame (“no” branch, decision block 210), then video obscuring program 106 determines whether there is an additional frame to review (decision block 214). In an embodiment, video obscuring program 106 loops through each frame of the video to obscure any detected PI objects in each frame. By obscuring PI objects in the video frame by frame, video obscuring program 106 prevents a viewer from pausing the video, or using a command line tool, on a particular frame to capture or extract PI. If video obscuring program 106 determines there is an additional frame to review (“yes” branch, decision block 214), then video obscuring program 106 returns to step 208.

Subsequent to reviewing each frame in the video for PI, i.e., performing steps 208 through 212 on each frame, (“no” branch, decision block 214), video obscuring program 106 determines whether PI is present in a sequence of video frames (decision block 216). In an embodiment, video obscuring program 106 determines whether a PI object is detected in consecutive frames of the video.

If video obscuring program 106 determines PI is present in a sequence of video frames (“yes” branch, decision block 216), then video obscuring program 106 determines a pattern of a position of the PI object (step 218). In an embodiment, video obscuring program 106 analyzes the consecutive frames that contain a PI object to identify a pattern of the position of the PI object in the frames. For example, consider PI objects x, y, and z. Video obscuring program 106 tracks the position of these objects as follows:
--xxxx-xxxx----
--yy-------------
--------zzz---zz---

where the dashes represent video frames with no PI objects detected.

Thus, video obscuring program 106 detects PI object x in four consecutive frames, fails to identify PI object x in one frame, and then identifies PI object x in the next four consecutive frames. Further, video obscuring program 106 identifies PI object y in two consecutive frames. Additionally, video obscuring program 106 identifies PI object z in three consecutive frames, fails to identify PI object z in three consecutive frames, and then identifies PI object z in the next two consecutive frames.

Video obscuring program 106 determines whether the PI object is missing in the pattern (decision block 220). In an embodiment, video obscuring program 106 determines whether an instance of PI may have been missed by determining whether the PI object is missing in at least one position of the detected pattern. Continuing the previous example, video obscuring program 106 determines that there is no missing object in the pattern of PI object y.

If video obscuring program 106 determines the PI object is missing in the pattern (“yes” branch, decision block 220), then video obscuring program 106 determines whether the PI object is missing in more than one frame (decision block 222). In an embodiment, video obscuring program 106 analyzes the detected pattern to determine whether the PI object is only missing in a single frame versus multiple frames in the video.

If video obscuring program 106 determines the PI object is not missing in more than one frame (“no” branch, decision block 222), then video obscuring program 106 obscures the PI object position in the single frame (step 224). In an embodiment, if video obscuring program 106 determines there is only one frame where the PI object is missing in the sequence, then video obscuring program 106 interpolates the position of the PI object in the frame in which the PI object is missing to fill the gap. Continuing the previous example, video obscuring program 106 interpolates the position of PI object x in the frame in which video obscuring program 106 did not detect PI object x and obscures that position in the frame that did not contain PI object x.

If video obscuring program 106 determines the PI object is missing in more than one frame (“yes” branch, decision block 222), then video obscuring program 106 determines whether the number of frames with the missing PI object exceeds a pre-defined threshold (decision block 226). In an embodiment, video obscuring program 106 compares the number of frames in a pattern or sequence that are missing the PI object with a pre-defined threshold number of missing frames to determine whether the PI object is actually missing or if the frames missing the PI object are “true negatives,” i.e., the PI object is not in the frame. In another embodiment, determines the number of seconds in the video where the PI object is missing and converts the number of seconds into a number of frames.

If video obscuring program 106 determines the number of frames missing the PI object exceeds a pre-defined threshold (“yes” branch, decision block 226), then video obscuring program 106 obscures the PI object position in multiple frames (step 228). In an embodiment, if video obscuring program 106 determines the number of frames in a sequence that are missing the PI object exceeds the pre-defined threshold number of missing frames, then video obscuring program 106 interpolates the position of the PI object in the frames in which the PI object is missing to fill the gap. Continuing the previous example, if the pre-defined threshold is two frames, then video obscuring program 106 interpolates the position of PI object z in the three frames in which video obscuring program 106 did not detect PI object z and obscures that position in the three frames that did not contain PI object z.

In an embodiment where video obscuring program 106 determines the PI object is missing in more than one frame, video obscuring program 106 performs a simple linear interpolation to calculate a trajectory, i.e., fit a curve onto the points that are available, to estimate the position of the missing PI objects. In another embodiment where video obscuring program 106 determines the PI object is missing in more than one frame, video obscuring program 106 performs a non-linear interpolation to calculate a trajectory between the points that are available. For example, video obscuring program 106 can perform a spline interpolation. In another example, video obscuring program 106 can perform a cubic interpolation. In an embodiment, video obscuring program 106 receives a selection of a preferred interpolation technique from the user, via user interface 112. Continuing the previous example, video obscuring program 106 uses spline interpolation to estimate the position of the three missing PI objects between the instances of PI object z and obscures the estimated positions in those frames.

Responsive to obscuring the PI object position in either a single frame or multiple frames, or if video obscuring program 106 determines PI is not present in a sequence of video frames (“no” branch, decision block 216), or if video obscuring program 106 determines the PI object is not missing in the pattern (“no” branch, decision block 220), then video obscuring program 106 obscures the position of the PI object in the previous frame and the next frame (step 230). In an embodiment, video obscuring program 106 adds obscuring to the frames that precede and follow the video frames that contain the determined PI object to ensure complete obscuring, even if those two frames were “false negatives,” i.e., a PI object exists in those frames, even though video obscuring program 106 did not detect it. In an embodiment, the number of frames to obscure prior to and following a video frame with a detected PI object may be selected by the user, via user interface 112.

In an embodiment, video obscuring program 106 performs the obscuring process described above on streaming video, using a buffer. Video obscuring program 106 considers the pre-defined threshold number of frames that can be missing the PI object, as discussed with respect to decision block 226, and adjusts the streaming buffer such that the number of frames in the buffer is large enough to provide at least the threshold number of frames.

FIG. 3 is an example diagram of a distributed data processing environment in which aspects of one or more of the illustrative embodiments may be implemented, and at least some of the computer code involved in performing the inventive methods may be executed, in accordance with an embodiment of the present invention, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing environment 300 contains an example of an environment for the execution of at least some of the computer code involved in performing the inventive methods, such as video obscuring program 106 for obscuring personal information in videos. In addition to video obscuring program 106, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and video obscuring program 106, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in video obscuring program 106 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid-state storage devices. Operating system 322 may take several forms, such as various known proprietary operating systems or open-source Portable Operating System Interface type operating systems that employ a kernel. The code included in video obscuring program 106 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way. EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more computer processors, a video;
extracting, by one or more computer processors, text from a first frame of the video;
determining, by one or more computer processors, a personal information object is detected in the extracted text;
obscuring, by one or more computer processors, the personal information object in the first frame; and
performing, by one or more computer processors, the previous steps on each frame in the video.

2. The computer-implemented method of claim 1, further comprising:
receiving, by one or more computer processors, a type of the personal information object for obscuring; and
receiving, by one or more computer processors, a method of obscuring the personal information object.

3. The computer-implemented method of claim 2, wherein the type of the personal information object includes at least one of: a name, contact information, an address, an email address, a phone number, a social security number, a driver's license number, a passport number, a credit card number, an account number, a license plate number, and medical information.

4. The computer-implemented method of claim 2, wherein the method of obscuring the personal information object includes at least one of: masking the personal information, blurring the personal information, and redacting the personal information.

5. The computer-implemented method of claim 1, further comprising:
determining, by one or more computer processors, the personal information object is detected in a sequence of frames;
determining, by one or more computer processors, a pattern of a position of the personal information object in the sequence of frames;
determining, by one or more computer processors, the personal information object is missing in one frame of the sequence of frames; and
obscuring, by one or more computer processors, a position in the one frame of the sequence of frames where the personal information object is missing.

6. The computer-implemented method of claim 5, further comprising:
determining, by one or more computer processors, the personal information object is missing in more than the one frame of the sequence of frames;
determining, by one or more computer processors, a number of frames of the more than one frame of the sequence of frames exceeds a pre-defined threshold; and
obscuring, by one or more computer processors, a position of the personal information object in the sequence of frames in the more than one frame where is the personal information object is missing.

7. The computer-implemented method of claim 1, further comprising:
obscuring, by one or more computer processors, a second position of the personal information object in a frame of the video prior to the first frame; and
obscuring, by one or more computer processors, a third position of the personal information object in a next frame of the video following a previously obscured frame.

8. A computer program product comprising:
one or more computer readable storage media;
program instructions, stored on at least one of the one or more computer readable storage media, to receive a video;
program instructions, stored on at least one of the one or more computer readable storage media, to extract text from a first frame of the video;
program instructions, stored on at least one of the one or more computer readable storage media, to determine a personal information object is detected in the extracted text;
program instructions, stored on at least one of the one or more computer readable storage media, to obscure the personal information object in the first frame; and
program instructions, stored on at least one of the one or more computer readable storage media, to perform the previous steps on each frame in the video.

9. The computer program product of claim 8, further comprising:
program instructions, stored on at least one of the one or more computer readable storage media, to receive a type of the personal information object for obscuring; and
program instructions, stored on at least one of the one or more computer readable storage media, to receive a method of obscuring the personal information object.

10. The computer program product of claim 9, wherein the type of the personal information object includes at least one of: a name, contact information, an address, an email address, a phone number, a social security number, a driver's license number, a passport number, a credit card number, an account number, a license plate number, and medical information.

11. The computer program product of claim 9, wherein the method of obscuring the personal information object includes at least one of: masking the personal information, blurring the personal information, and redacting the personal information.

12. The computer program product of claim 8, further comprising:
program instructions, stored on at least one of the one or more computer readable storage media, to determine the personal information object is detected in a sequence of frames;
program instructions, stored on at least one of the one or more computer readable storage media, to determine a pattern of a position of the personal information object in the sequence of frames;
program instructions, stored on at least one of the one or more computer readable storage media, to determine the personal information object is missing in one frame of the sequence of frames; and
program instructions, stored on at least one of the one or more computer readable storage media, to obscure a position in the one frame of the sequence of frames where the personal information object is missing.

13. The computer program product of claim 12, further comprising:
program instructions, stored on at least one of the one or more computer readable storage media, to determine the personal information object is missing in more than the one frame of the sequence of frames;
program instructions, stored on at least one of the one or more computer readable storage media, to determine a number of frames of the more than one frame of the sequence of frames exceeds a pre-defined threshold; and
program instructions, stored on at least one of the one or more computer readable storage media, to obscure a position of the personal information object in the sequence of frames in the more than one frame where is the personal information object is missing.

14. The computer program product of claim 8, further comprising:
program instructions, stored on at least one of the one or more computer readable storage media, to obscure a second position of the personal information object in a frame of the video prior to the first frame; and
program instructions, stored on at least one of the one or more computer readable storage media, to obscure a third position of the personal information object in a next frame of the video following a previously obscured frame.

15. A computer system comprising:
one or more computer processors;
one or more computer readable memories; and
one or more computer readable storage media;
program instructions, stored on at least one of the one or more computer readable storage media for execution by at least one of the one or more computer processors via at least one of the one or more memories, to receive a video;
program instructions, stored on at least one of the one or more computer readable storage media for execution by at least one of the one or more computer processors via at least one of the one or more memories, to extract text from a first frame of the video;
program instructions, stored on at least one of the one or more computer readable storage media for execution by at least one of the one or more computer processors via at least one of the one or more memories, to determine a personal information object is detected in the extracted text;
program instructions, stored on at least one of the one or more computer readable storage media for execution by at least one of the one or more computer processors via at least one of the one or more memories, to obscure the personal information object in the first frame; and
program instructions, stored on at least one of the one or more computer readable storage media for execution by at least one of the one or more computer processors via at least one of the one or more memories, to perform the previous steps on each frame in the video.

16. The computer system of claim 15, further comprising:
program instructions, stored on at least one of the one or more computer readable storage media for execution by at least one of the one or more computer processors via at least one of the one or more memories, to receive a type of the personal information object for obscuring; and
program instructions, stored on at least one of the one or more computer readable storage media for execution by at least one of the one or more computer processors via at least one of the one or more memories, to receive a method of obscuring the personal information object.

17. The computer system of claim 16, wherein the method of obscuring the personal information object includes at least one of: masking the personal information, blurring the personal information, and redacting the personal information.

18. The computer system of claim 15, further comprising:
program instructions, stored on at least one of the one or more computer readable storage media for execution by at least one of the one or more computer processors via at least one of the one or more memories, to determine the personal information object is detected in a sequence of frames;
program instructions, stored on at least one of the one or more computer readable storage media for execution by at least one of the one or more computer processors via at least one of the one or more memories, to determine a pattern of a position of the personal information object in the sequence of frames;
program instructions, stored on at least one of the one or more computer readable storage media for execution by at least one of the one or more computer processors via at least one of the one or more memories, to determine the personal information object is missing in one frame of the sequence of frames; and
program instructions, stored on at least one of the one or more computer readable storage media for execution by at least one of the one or more computer processors via at least one of the one or more memories, to obscure a position in the one frame of the sequence of frames where the personal information object is missing.

19. The computer system of claim 18, further comprising:
program instructions, stored on at least one of the one or more computer readable storage media for execution by at least one of the one or more computer processors via at least one of the one or more memories, to determine the personal information object is missing in more than the one frame of the sequence of frames;
program instructions, stored on at least one of the one or more computer readable storage media for execution by at least one of the one or more computer processors via at least one of the one or more memories, to determine a number of frames of the more than one frame of the sequence of frames exceeds a pre-defined threshold; and
program instructions, stored on at least one of the one or more computer readable storage media for execution by at least one of the one or more computer processors via at least one of the one or more memories, to obscure a position of the personal information object in the sequence of frames in the more than one frame where is the personal information object is missing.

20. The computer system of claim 15, further comprising:
program instructions, stored on at least one of the one or more computer readable storage media for execution by at least one of the one or more computer processors via at least one of the one or more memories, to obscure a second position of the personal information object in a frame of the video prior to the first frame; and
program instructions, stored on at least one of the one or more computer readable storage media for execution by at least one of the one or more computer processors via at least one of the one or more memories, to obscure a third position of the personal information object in a next frame of the video following a previously obscured frame.
